(19) United States
(12) Patent Application Publication
(10) Pub. No.: US 2010/0000342 A1
(43) Pub. Date: Jan. 7, 2010

(54) NEEDLE AND DEVICE FOR SOLID PHASE MICRO EXTRACTION

(76) Inventor: Thierry Zesiger, Marin-Epagnier (CH)

Correspondence Address: NIXON & VANDERHYE, PC, 901 NORTH GLEBE ROAD, 11TH FLOOR, ARLINGTON, VA, 22203, US

(21) Appl. No.: 12/520,596

(22) PCT Filed: Dec. 20, 2007
(86) PCT No.: PCT/IB07/55246

§ 371 Date: Aug. 11, 2009

(30) Foreign Application Priority Data
Dec. 22, 2006 (EP) 06127003.9

(51) Int. Cl. G01N 35/10; B23P 11/00; B01L 3/02

(52) U.S. Cl. 73/864.11; 29/428; 422/100

(57) ABSTRACT

The invention relates to a hollow needle (1) having a geometry adapted to SPME and including a tip (5) as well as an adsorbant material (2) provided in the needle at a distance from the tip (5), characterised in that it comprises a plurality of side holes (4) formed in a region of the side wall of the needle, said region being located between the tip (5) and the location where the adsorbant material (2) is provided. The invention also relates to a method for producing the hollow needle (1). The invention further relates to a device using the above-mentioned needle in combination with a vessel and suction means.

### FIELD OF THE INVENTION

The present invention relates to the field of solid-phase microextraction that is commonly called SPME. The invention relates more precisely to a needle that can be used in the context of SPME.

### DESCRIPTION OF THE PRIOR ART

SPME is an effective tool for obtaining a preliminary concentration of a sample, such as an aqueous solution, containing an organic compound intended to be analyzed, for example by means of gas chromatography (GC).

Accordingly, use is preferably made of a hollow needle in which an adsorbent material is placed. The latter may take the form of a coating of the internal wall of the needle, of a mass consisting of a copolymer or of a cluster of solid particles that are free, that is to say not fixed by a binder.

As an example, European patent application EP 1 411 068 Al describes an adsorbent material in the form of copolymer and American patent application us 2001/0032521 A1 introduces an adsorbent material in the form of quartz wool.

The adsorption phase consists in having the sample pass through the adsorbent material, usually several times. Desorption is preferably carried out by heating, directly in the injection port of the analysis apparatus, for example the chromatograph.

During the adsorption and desorption operations, the hollow needle must be inserted into a receptacle (for example a phial, a syringe, a GC injector, etc.) furnished with a port which is closed off by a septum. In order to make it pass more easily through the septum, the needle preferably comprises a sharpened distal end.

The hollow needles of the prior art however have certain disadvantages. For example, when they pass through a septum, fragments of the latter may accidentally enter the needle, thereby causing a partial or total obstruction to the flow of the sample into the needle.

There is therefore a need to be able to remedy the abovementioned problem.

Moreover, another problem is observed with the needles of the prior art.

The presence of an absorbent material in the needle causes a considerable loss of pressure, to such a point that a secondary pumping system becomes necessary in order to allow the head space laden with volatile organic substances (VOCs) a fortiori the liquids, to effectively pass through the adsorbent material. It should however be noted that the simple fact of “pumping” by means of a back-and-forth movement of the piston of a syringe—as for example mentioned in the Lipinski article (Lipinski, J., Fresenius J. Anal. Chem., vol 369 (2001) p 57 or the HP and Chromtech patents)—does not generate sufficient aspiration of the gas. To obtain a sufficient performance, a large number of cycles must be carried out, which causes preparation times that are too long for an optimal use in routine analysis.

There is therefore also a need to improve the passage of the fluid through the needle.

### SUMMARY OF THE INVENTION

The present invention provides the benefit of remedying notably the problems explained in the preceding section.

Accordingly, it relates to a hollow needle with a geometry suitable for SPME and comprising a tip and an adsorbent material placed in the needle at a certain distance from the tip, characterized in that it comprises several lateral holes placed in a region of the lateral wall of the needle, said region being situated between the tip and the place where said adsorbent material is placed.

Advantageously, the tip of the needle is closed.

It is appropriate to emphasize that having several lateral holes considerably increases the cross section through which the fluid passes, which has the effect of improving the performance of the microextraction. The use of a single lateral hole, as may be found in needles not intended for SPME, see for example EP 0 275 119 A2, is therefore not recommended in the present case. Only the presence of several lateral holes can improve the performance of the device.

According to one embodiment of the invention, the holes are placed between the adsorbent material and the tip of the needle.

According to another embodiment, at least a portion of the holes is situated at the height of the adsorbent material.

It is also possible to place all of the holes at the level of the adsorbent material.

Preferably, the adsorbent material consists of a cluster of particles that are not bound together.

Clearly, the adsorbent material may consist of any other substance/structure known to those skilled in the art, for example quartz wool, a copolymer or a coating on the internal wall of the needle.

When the adsorbent material consists of unbound particles, holes are preferably chosen whose diameter is such that the particles can be retained in the needle. Usually, the diameter of the holes is therefore smaller than that of the smallest particle.

In order to keep the cluster of particles in a determined position, use is preferably made of first retention means, for example a chicane, which are suitable for retaining the cluster on the side of the proximal end of the needle.

Second retention means may also be placed on the side of the tip of the needle. The latter are particularly useful, and even necessary, if the tip of the needle is not closed.

The needle may also have one or more grooves situated toward its free end. In this configuration, at least a portion of the holes is placed in the groove or grooves.

The presence of a groove has the effect of stiffening the tip of the needle and of preventing the holes from being blocked by fragments of septum that may be removed during the passage of the needle. Specifically, the holes thus placed never come into direct contact with the septum.

In another embodiment, the needle comprises a first hole placed between the tip and the adsorbent material and a second hole placed between the first hole and the adsorbent material.

Advantageously, the diameter of the second hole is smaller than the diameter of the first hole.

According to a variant, the needle comprises more than two holes placed successively along the needle.

As a nonlimiting example, the internal diameter of the needle is situated between 0.5 and 0.7 mm while the diameter of the lateral holes preferably varies between 50 and 10 microns.

According to a particular embodiment of the invention, the total of the cross sections of the lateral holes is greater than the internal cross section of the needle. In this configuration, the flow of the fluid through the needle is greatly improved. In all cases, it is better than the flow of fluid through a needle with no lateral holes.

The invention also relates to an SPME device comprising a needle as defined in any one of the preceding three paragraphs, a receptacle furnished with a closure element suitable for being pierced by said needle and aspiration means designed to aspirate through the needle a fluid contained initially in the receptacle, said needle also being mounted so as to be able to move relative to the receptacle, so as to be at least in a first position and a second position; the first position being defined by placing the two holes in communication with the inside of the receptacle, the second position being defined by placing the second hole in communication with the open air and placing the first hole in communication with the inside of the receptacle.

The invention also relates to the use of the device described above, the use being characterized by the following steps:
placing the needle in the first position,
aspiration,
moving the needle so as to place the second hole in communication with the open air,
ceasing the aspiration.

Alternatively, the use is characterized by the following steps:
placing the needle in the second position,
aspiration,
ceasing the aspiration.

Advantageously, a volume of head space, that may or may not be quantifiable, is passed through the ad/absorbent phase by means of an external pump.

According to an equally preferable variant of the invention, the ad/absorbent phase is cleaned by immersion in a heated oven or, before or only, in a solvent suitable for preventing the memory effects, that is to say, for completely eliminating the traces and residues originating from the previous analysis and not totally desorbed during the injection.

Preferably, the desorption of the residues originating from the previous sample is assisted by the application of a vacuum, at least a partial vacuum, on the adsorbent needle in order to make it easier to clean; this partial vacuum being able to be combined or not combined with a heating and/or a cleaning via an appropriate solvent.

Advantageously, the system for producing the vacuum is itself used for the preconcentration of the sample. According to one embodiment of the invention, the device comprises a valve which makes it possible to switch from a preconcentration mode to a cleaning (or packaging) mode.

Finally the invention relates to a method for manufacturing a needle as defined above. The method is characterized by the following steps:
preparation of a hollow needle furnished with lateral holes,
optional insertion of first retention means, for example a chicane,
insertion via the tip of the adsorbent material,
optional insertion of second retention means via the tip of the needle,
optional closure of the tip by squeezing the walls of the needle,
optional manufacture of a sharpened free end.

This therefore gives a much better transfer if the preconcentration needle can be connected to an external vacuum source. The latter may be either a pump or a predetermined volume previously evacuated (loop). In the case of samples packaged in hermetically sealed flasks the closure of which contains a septum, the aspiration must be precisely controlled. Too strong an aspiration or lasting too long would exhaust the content of the flask with no hope of being able to make the sample pass again through the adsorbent as is the case with the back-and-forth movements. However, the latter method has other defects, notably of depending heavily on the pressure prevailing inside the hermetically sealed flask, and of possible leaks that are still possible at the piston of the syringe. When using an appended (auxiliary) pump, it is therefore appropriate to adjust the pump vacuum, the aspiration flow or its operating time. All these parameters are easily available to those skilled in the art. It should be noted that the syringe carrying the adsorbent needle described here must have at least one port, for example a lateral port, to which the auxiliary pump will be connected.

One of the preferred possibilities of use of an appended pumping system consists in engaging a pump connected to the syringe for a time sufficient for a known and constant volume, but markedly less than the volume of gas contained in the flask, to be aspirated and carried through the adsorbent. In a second phase, called the relaxation phase, the user refills the flask with a gas or air volume that is practically equivalent to that which has been aspirated in order to increase its internal pressure. A new aspiration cycle can then be repeated and so on until the desired preconcentration factor is obtained. The addition of gas in the relaxation cycle may be carried out by a leak arranged at the flask (by the insertion of a second needle for example) or by the syringe if the latter can be connected to a source of gas in addition to its connection to a vacuum source. A third variant is described in the particular execution below.

### DETAILED DESCRIPTION OF THE INVENTION

The invention will be described in greater detail by means of the following figures:

FIG. 1 is a schematic representation of one embodiment of a needle according to the invention.

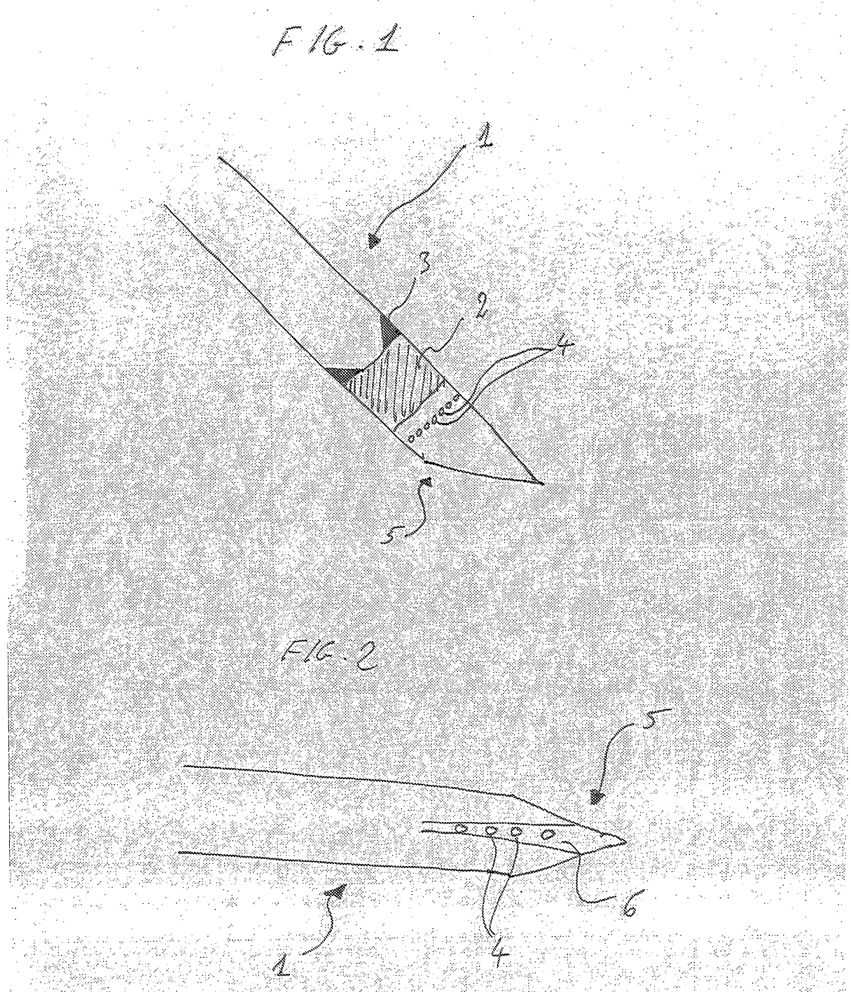

FIG. 2 is a schematic representation of the free end of a needle which comprises a groove.

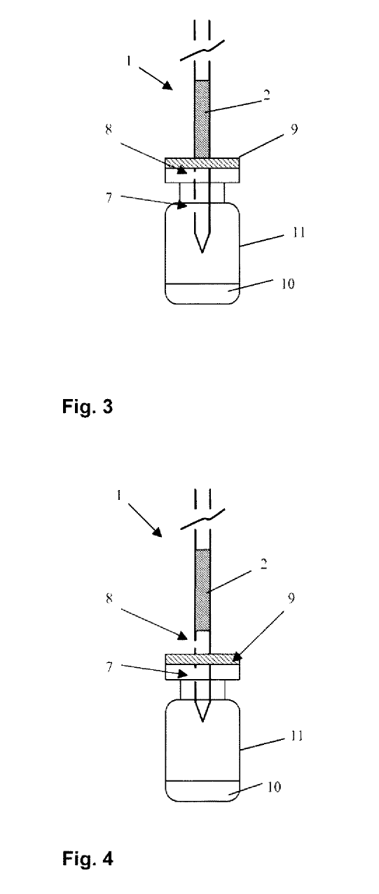

FIG. 3 is a schematic representation of a device according to the invention in which the needle is in a first position.

FIG. 4 is a schematic representation of a device according to the invention in which the needle is in a second position.

According to the embodiment of FIG. 1, the hollow needle 1 is mounted directly, or via a pipe or tube, at the end of a syringe or a suction pump or of a vacuum element (canister). These elements are not illustrated. The needle 1 may be fixed or removable. It is preferably made of steel or another hard metal.

On the inside, the needle 1 contains an adsorbent material 2 in the form of solid particles that are free, that is to say not fixed by a binder. The sample (liquid or gaseous) adsorption phase is carried out by activating the piston of the syringe upward and then downward alternately, or by drawing off the desired volume of the fluid by means of a pump or a vacuum system. Desorption is carried out preferably by heating, usually directly in the injection port of the analysis apparatus (chromatograph). If necessary, if the adsorbent material 2 withstands it, this operation may be carried out by rinsing in an appropriate solvent.

The adsorbent material 2 is placed in the needle somewhat toward the tip so that the latter is conveniently submerged in the hot zone of the injector for an optimal thermal desorption. The adsorbent material 2 which may be active carbon, or any other solid adsorbent, notably a polymer (Tenax™, sol-gel, etc.) is kept in place in the needle 1 by one or more “chicanes” 3 allowing the fluid to pass freely but retaining the particles. To fill the needle 1, the user proceeds in the following manner: he initially uses a needle with no tip but furnished with lateral holes 4. Via one of the ends of the needle, he first inserts the chicane 3, the design of which may be variable; he then inserts by aspiration the adsorbent material 2, preferably screened, and with a particle size of between 100 and 500 microns. The quantity of adsorbent material 2 is determined by weighing and/or by checking the position of the bed by carefully inserting an element making it possible to determine the final position of the adsorbent material 2 (for example the same type of tool making it possible to insert and correctly position the chicane 3). A second chicane (not shown) may be mounted after the absorbent material in order to prevent it from coming out again. The needle 1 is finally pinched and/or closed by any means known to those skilled in the art, in order also to form a sharpened end.

Alternatively, it is possible to insert an adsorbent material 2 consisting of a mixture of polymers or to insert various polymers in successive layers.

The lateral holes 4 are positioned on the side of the tip 5 of the needle 1, toward the base of the adsorbent material 2 or at the second chicane if such an element is installed. Using a multitude of lateral holes 4 ensures better operation of the needle 1 by allowing an optimal flow of the sample to be preconcentrated. A single lateral hole would specifically be insufficient because the latter can be easily blocked by an adsorbent particle or an external particle (pieces of septum) . A single hole at the tip of the needle should also be avoided because of the risks of blockage by fragments of septum. If necessary, it is possible to provide a plurality of lateral holes and one hole at the tip of the needle.

Advantageously, when the absorbent material consists of unbound particles, the user uses a high number of small holes with a diameter that is smaller than the smallest adsorbent particle. This configuration creates a filter making it possible to keep the particles inside the needle and does not therefore make it necessary to use a second chicane.

In a particular execution of the invention (see FIG. 2), the holes 4 are placed inside a groove 6 arranged along the needle 1, preferably toward its free end. Several grooves may be arranged, each being able to comprise one or more holes. These grooves have the effect of stiffening the tip of the needle and preventing the holes being obstructed by fragments of septum. Specifically, the holes thus placed never come into direct contact with the septum.

It goes without saying that the invention is not limited to the embodiments of the needle set out above. Any number, dimension or arrangement of the lateral holes forms part of the invention.

Similarly, the invention is not limited to the method described above. It also covers any method making it possible to produce a hollow needle comprising an adsorbent material and lateral holes.

FIG. 3 illustrates a variant of the invention wherein the holes are placed along the needle, so as to limit the aspiration in the flask 11. The holes 7, 8 are all placed beneath the adsorbent 2. The bottom hole 7 or the holes 7 (if several are arranged at the same height) is/are placed right at the bottom toward the tip of the needle 1. It is through this/these hole(s) that the analyte is inserted into the needle 1. The top hole 8 is placed higher, between the bottom hole 7 and the adsorbent. The top hole 8 is designed to produce a leak and usually has a smaller diameter than that of the bottom hole 7. If, during the use of such a needle 1, the holes 7 and 8 are fully inserted inside the sealed flask 11, the operation is as described above wherein a source of vacuum and of gas are activated alternately.

FIG. 3 illustrates a normal use in which the two holes 7, 8 are inside the sealed flask 11 containing the sample 10.

The two holes 7, 8 are placed beneath the adsorbent 2. Note that the top hole 8 is smaller than the bottom hole 7.

If, however, the needle 1 does not totally penetrate the flask 11 and the top hole 8 remains above the septum 9, that is to say in the open air (see FIG. 4), this intentionally limits the vacuum in the flask 11 because of the arranged leak. Interrupting the pumping allows the air to re-enter through the top hole 8 that remains on the outside and to reestablish atmospheric pressure in the flask 11. A second pumping cycle identical to the first can then be initiated.

FIG. 4 therefore illustrates a particular case in which the top hole 8 is on the outside while the bottom hole 7 is in the sealed flask 11 containing the sample 10.

By aspirating by means of a pump for example, the user dilutes the sample with air entering through the top hole 8. This does not use up the sample 10 too quickly. The flow through the bottom hole 7 stops spontaneously when the pressure in the flask 11 reaches a certain vacuum. Stopping the pump allows the flask 11 to return to atmospheric pressure because the air re-enters through the top hole 8 and comes out in the flask 11 through the bottom hole 7. This system provides the advantage of dispensing with a valve. In this case, only the pump would be switched via an electric relay.

In a variant in which considerable pumping must be carried out, it would be appropriate to insert the needle until it reaches a position similar to that of FIG. 3 in the aspiration phase. After a pumping time defined by the method, if the syringe does not have a second port for the insertion of a gas, (the first already being used for pumping), it is then possible to reestablish the pressure in the flask 11 by simply raising the needle 1 to the position defined by FIG. 4 in which the top hole 8 is in the open air. Before restarting a pumping cycle, the needle 1 must be pushed in again.

In a particular variant, that is not illustrated, of what has just been described, several holes are placed along the needle but still beneath the adsorbent (like a flute). By changing the penetration of the needle in the septum, the user leaves more or fewer holes outside, thus making it possible to modulate the final vacuum inside the flask.

It is noted therefore that, with the method described in the present invention, only one valve connected to a pump is required, or only one electrically switchable vacuum pump and the possibility of precisely raising and lowering the needle in the flask containing the sample, in order to reproduce aspiration cycles that are more powerful and regular than simple back-and-forth movements of the piston of a syringe. With the system described here, the time to prepare the sample is considerably reduced and is made more precise and more reproducible than with the back-and-forth movements carried out with the systems of the prior art.

It goes without saying that the invention is not limited to the illustrated and unillustrated examples discussed above.

1. A hollow needle (1) with a geometry suitable for SPME and comprising a tip (5) and an adsorbent material (2) placed in the needle at a certain distance from the tip (5), characterized in that it comprises several lateral holes (4) placed in a region of the lateral wall of the needle, said region being situated between the tip (5) and the place where said adsorbent material (2) is placed.

2. The hollow needle as claimed in claim 1, characterized in that the tip (5) is closed.

3. The hollow needle as claimed in claim 1, characterized in that the holes (4) are situated between the adsorbent material (2) and the tip (5).

4. The hollow needle as claimed in claim 1, characterized in that at least a portion of the holes (4) is situated at the height of the adsorbent material (2).

5. The hollow needle as claimed in claim 1, characterized in that the adsorbent material (2) consists of a cluster of unbound particles.

6. The hollow needle as claimed in claim 5, characterized in that the diameter of the holes (4) is designed so as to retain the particles in the needle (1).

7. The hollow needle as claimed in claim 5, characterized in that it comprises first retention means (3) suitable for retaining the adsorbent material (2) on the proximal side of the needle (1).

8. The hollow needle as claimed in claim 7, characterized in that it comprises second retention means suitable for retaining the adsorbent material (2) on the side of the tip (5) of the needle (1).

9. The hollow needle as claimed in claim 1, comprising a groove (6) placed toward its free end (5), the holes (4) being placed in said groove (6).

10. The hollow needle as claimed in claim 1, comprising a first hole (7) placed between the tip (5) and the adsorbent material (2) and a second hole (8) placed between the first hole (7) and the adsorbent material (2).

11. The hollow needle as claimed in claim 10, wherein the diameter of the second hole (8) is smaller than the diameter of the first hole (7).

12. The hollow needle as claimed in claim 10, comprising more than two holes placed successively along the needle.

13. An SPME device comprising a needle as defined in claim 10, a receptacle furnished with a closure element suitable for being pierced by said needle and aspiration means designed to aspirate through the needle a fluid contained initially in the receptacle, said needle also being mounted so as to be able to move relative to the receptacle, so as to be at least in a first position and a second position; the first position being defined by placing the two holes (a, b) in communication with the inside of the receptacle, the second position being defined by placing the second hole (8) in communication with the open air and placing the first hole (7) in communication with the inside of the receptacle.

14. A method for manufacturing a hollow needle (1) as claimed in claim 1, characterized by the following steps:
preparation of a hollow needle (1) with no tip, furnished with lateral holes (4),
optional insertion of first retention means (3),
insertion via the tip (5) of the adsorbent material (2),
optional insertion via the tip (5) of second retention means, optional closure of the tip (5) by squeezing the walls of the needle (1),
optional manufacture of a sharpened free end (5).

15. The use of the device as defined in claim 13, characterized by the following steps:
placing the needle in the first position,
aspiration,
moving the needle so as to place the second hole (8) in communication with the open air,
ceasing the aspiration.

16. The use of the device as defined in claim 13, characterized by the following steps:
placing the needle in the second position,
aspiration,
ceasing the aspiration.
